(19) United States
(12) Patent Application Publication
(10) Pub. No.: US 2010/0097715 A1
(43) Pub. Date: Apr. 22, 2010

(54) NANOIMPRINTING RESIN COMPOSITION

(75) Inventors: Yuko Sakata, Minato-ku (JP); Hiroshi Uchida, Minato-ku (JP); Katsumasa Hirose, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku, Tokyo (JP)

(21) Appl. No.: 12/528,400

(22) PCT Filed: Feb. 21, 2008
(86) PCT No.: PCT/JP2008/052966

§ 371 Date: Aug. 24, 2009

(30) Foreign Application Priority Data
Feb. 26, 2007 (JP) 2007-046111

(51) Int. Cl. G11B 5/02; C08K 3/22; C08K 3/36; B29C 59/02; B29C 35/08; D06N 7/04; B29C 59/00; G11B 5/82

(52) U.S. Cl. 360/55; 524/783; 524/847; 264/293; 264/496; 428/141; 360/135; G9B/5.293; G9B/5.024

(57) ABSTRACT

Nanoimprinting resin compositions are cured quickly and uniformly, are patterned by transferring evenly without transfer failure, and are suited for UV nanoimprinting methods and thermal nanoimprinting methods. The invention also provides micropatterned films of the compositions and processes for producing such films, magnetic disk media obtained with the films and production processes therefor, and recording/reproducing apparatuses for recording information in the magnetic disk media or for reproducing information from the magnetic disk media.

The nanoimprinting resin compositions essentially contain (a) a compound having at least one polymerizable group in the molecule, and (b) organic or inorganic fine particles.

### FIELD OF THE INVENTION

The present invention relates to nanoimprinting resin compositions essentially containing:

(a) a compound having at least one polymerizable group in the molecule, and

(b) organic or inorganic fine particles. The invention also relates to micropatterned films of the compositions and processes for producing such films, magnetic disk media obtained with the films and production processes therefor, and recording/reproducing apparatuses for recording information in the magnetic disk media or for reproducing information from the magnetic disk media.

### BACKGROUND OF THE INVENTION

In the manufacturing of semiconductor chips and various recording media, micropatterns are formed by techniques such as electron beam lithography or focused ion beam lithography. However, these techniques involve a plurality of steps including photoexposure and development and have a problem of small throughput (capacity per unit time).

Nanoimprinting methods have been used as alternatives to electron beam lithography and focused ion beam lithography (Patent Document 1). In a nanoimprinting process, a mold is pressed against a substrate and thereby the pattern of the mold is transferred to the resin on the substrate. Nanoimprinting permits fine processing at submicron order or less with a high throughput.

The nanoimprinting methods include UV nanoimprinting methods wherein a mold and a film are pressed together and the film is UV irradiated, and thermal nanoimprinting methods wherein a film is heated in a pressed contact with a mold. These methods provide satisfactory pattern transfer precision and resolution, and are expected to be used in the manufacturing of semiconductor devices in particular (Patent Document 2). In these processes, a mold having fine patterns is pressed against a liquid or soft resin and the resin is cured in the pressed state and is patterned with high transfer precision.

However, general resins (polymer materials) tend to recover from elastic deformation after the pressure is removed particularly in the case of micropatterns, and long pressing is required to obtain sufficient plastic deformation.

### Patent Document 1: JP-A-2000-232095

### Patent Document 2: JP-A-2006-521682

### SUMMARY OF THE INVENTION

The present invention aims to solve the problems in the art as described above. It is therefore an object of the invention to provide nanoimprinting resin compositions that are cured quickly and uniformly, are patterned by transferring evenly without transfer failure or unevenness, and are suited for UV nanoimprinting methods and thermal nanoimprinting methods.

It is another object of the invention to provide micropatterned films of the compositions and processes for producing such films, magnetic disk media obtained with the films and production processes therefor, and recording/reproducing apparatuses for recording information in the magnetic disk media or for reproducing information from the magnetic disk media.

The present inventors studied diligently to achieve the above objects. They have then found that nanoimprinting resin compositions essentially containing:

(a) a compound having at least one polymerizable group in the molecule, and

(b) organic or inorganic fine particles

are suited for UV nanoimprinting methods and thermal nanoimprinting methods.

In detail, the invention relates to the following 1 to 14.

1. A nanoimprinting resin composition comprising as essential components:

(a) a compound having at least one polymerizable group in the molecule, and

(b) organic or inorganic fine particles.

2. The nanoimprinting resin composition described in 1 above, wherein not less than 30% by mass of the component (a) is a compound having at least two polymerizable groups in the molecule.

3. The nanoimprinting resin composition described in 1 or 2 above, wherein not less than 30% by mass of the component (a) is a compound having at least one (meth)acryloyl group in the molecule.

4. The nanoimprinting resin composition described in any one of 1 to 3 above, wherein the component (b) is inorganic fine particles having an average particle diameter of not more than 100 nm.

5. The nanoimprinting resin composition described in 4 above, wherein the inorganic fine particles are at least one kind selected from the group consisting of silica fine particles, zirconia fine particles and titania fine particles.

6. The nanoimprinting resin composition described in any one of 1 to 5 above, wherein the component (a) and the component (b) are used in a ratio of 100 parts by mass of the component (a) and 10 to 400 parts by mass of the component (b).

7. The nanoimprinting resin composition described in any one of 1 to 6 above, wherein the nanoimprinting resin composition further comprises a polymerization initiator (c).

8. The nanoimprinting resin composition described in 7 above, wherein the component (c) is used in an amount of 0.01 to 10 parts by mass based on 100 parts by mass of the component (a).

9. A process for producing micropatterned films comprising applying the nanoimprinting resin composition of any one of 1 to 8 above to a substrate and patterning the composition by a nanoimprinting method.

10. The process for producing micropatterned films according to 9 above, wherein the composition is patterned by pressing a mold against the composition and applying a UV light having a wavelength of not more than 400 nm.

11. A micropatterned film obtained by the process described in 9 or 10 above.

12. A process for manufacturing magnetic disk media, comprising patterning a magnetic layer through the micropatterned film described in 11 above as a mask or through a masking material patterned through the micropatterned film as a mask, by demagnetizing or removing a portion of the disk that is not masked.

13. A magnetic disk medium obtained by the process described in 12 above.

14. A recording/reproducing apparatus for recording information in or reproducing information from the magnetic disk medium described in 13 above.

### ADVANTAGEOUS EFFECTS OF THE INVENTION

The nanoimprinting resin compositions allow for high-precision and high-throughput production of micropatterned films that are used in the manufacturing of silicon wafers or high-density magnetic recording media.

### BRIEF DESCRIPTION OF THE DRAWINGS

FIG. 1 is a top view of a patterned face of a nanoimprinting mold prepared from a 1.8 inch diameter quartz glass circular plate. In the figure, the radial lines have a width of 0.1 mm and indicate portions patterned with imprinting patterns. In the figure, depressions (width: L) and projections (width: S) are alternately provided in the radius direction. The width of the depressions is 80 nm in the radius direction, and the width of the projections is 120 nm in the radius direction.

In the enlarged view, the upper illustration is a plan view (an upper view) and the lower illustration is a cross sectional view.

FIG. 2 is an enlarged partial upper view of the imprinting pattern in FIG. 1.

In the figure, the length of 0.1 mm corresponds to the width of the line indicating the imprinting pattern in FIG. 1, and depressions and projections are alternately provided in the radius direction in FIG. 1. The width of the depressions is 80 nm in the radius direction in FIG. 1, and the width of the projections is 120 nm in the radius direction in FIG. 1. The resin composition according to the invention is filled in the depressions.

FIG. 3 is a cross sectional side view of the part shown in FIG. 2. The depth of the depressions is 150 nm.

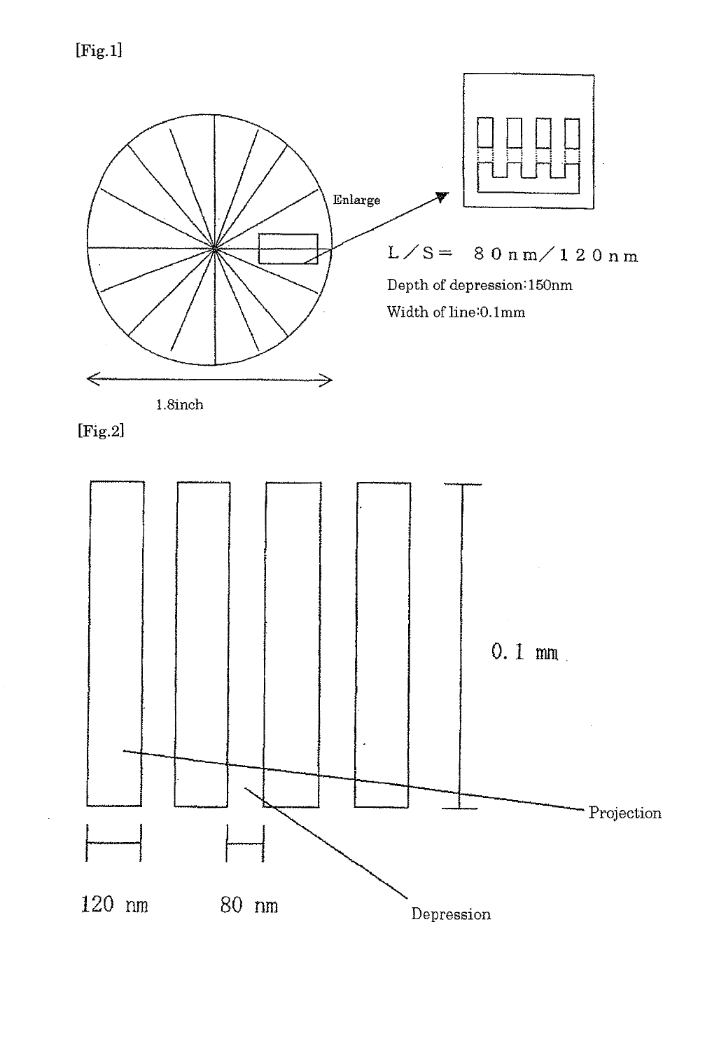

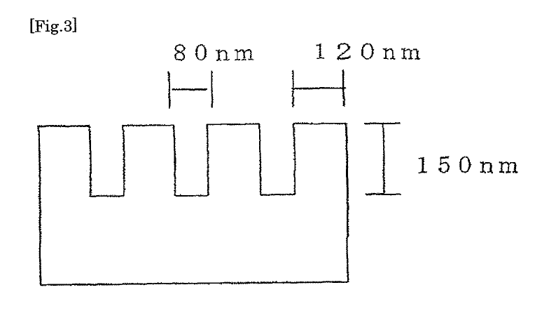

### PREFERRED EMBODIMENTS FOR CARRYING OUT THE INVENTION

The nanoimprinting resin compositions according to the present invention will be described in detail hereinbelow.

The nanoimprinting resin composition includes as essential components:

(a) a compound having at least one polymerizable group in the molecule, and

(b) organic or inorganic fine particles.

The component (a) may be a single or two or more compounds having at least one polymerizable group in the molecule. The number of the polymerizable groups in the molecule is not particularly limited. However, in view of curing rate in the pattern formation and physical and chemical durability of the cured films, it is preferable that not less than 30% by mass, and more preferably not less than 50% by mass of the component (a) is a compound having two or more polymerizable groups in the molecule.

The polymerizable groups in the component (a) are not limited as long as reaction is induced by light or heat. Preferred polymerizable groups include (meth)acryloyl groups, vinyl groups, allyl groups, epoxy groups and oxetanyl groups. Of the polymerizable groups, it is preferable that a compound having a (meth)acryloyl group is used at not less than 30% by mass of the component (a), whereby the curing time is further shortened and higher throughput is achieved.

Examples of the compounds having one (meth)acryloyl group include:

mono(meth)acrylates such as methyl(meth)acrylate, ethyl(meth)acrylate, n-propyl(meth)acrylate, isopropyl(meth)acrylate, n-butyl(meth)acrylate, isobutyl(meth)acrylate, sec-butyl(meth)acrylate, hexyl(meth)acrylate, octyl(meth)acrylate, 2-ethylhexyl(meth)acrylate, decyl(meth)acrylate, isobornyl(meth)acrylate, cyclohexyl(meth)acrylate, phenyl(meth)acrylate, benzyl(meth)acrylate, 2-hydroxyethyl(meth)acrylate, 2-hydroxypropyl (meth)acrylate, 3-hydroxypropyl(meth)acrylate, 2-hydroxybutyl(meth)acrylate and 2-hydroxyphenylethyl (meth)acrylate; and

(meth)acrylamides such as N,N-dimethyl (meth)acrylamide, N,N-diethyl(meth)acrylamide and N-acryloylmorpholine.

Examples of the compounds having two or more (meth)acryloyl groups include:

polyfunctional (meth)acrylates such as ethylene glycol di(meth)acrylate, propylene glycol di(meth)acrylate, 1,4-butanediol di(meth)acrylate, diethylene glycol di(meth)acrylate, triethylene glycol di(meth)acrylate, trimethylolpropane di(meth)acrylate, trimethylolpropane tri(meth)acrylate and pentaerythritol penta(meth)acrylate; and

epoxy(meth)acrylates that are adducts of epoxy resins such as bisphenol A epoxy resin, hydrogenated bisphenol A epoxy resin, brominated bisphenol A epoxy resin, bisphenol F epoxy resin, novolak epoxy resin, phenol novolak epoxy resin, cresol novolak epoxy resin, alicyclic epoxy resin, N-glycidyl epoxy resin, bisphenol A novolak epoxy resin, chelate epoxy resin, glyoxal epoxy resin, amino group-containing epoxy resin, rubber-modified epoxy resin, dicyclopentadiene phenolic epoxy resin, silicone-modified epoxy resin and ε-caprolactone-modified epoxy resin, with (meth)acrylic acid.

Examples of the compounds having one vinyl group include:

monovinyl ethers such as n-propyl vinyl ether, isopropyl vinyl ether, n-butyl vinyl ether, isobutyl vinyl ether, 2-ethylhexyl vinyl ether, octadecyl vinyl ether and cyclohexyl vinyl ether;

monovinyl esters such as vinyl acetate, vinyl propionate, vinyl butyrate and vinyl benzoate;

divinyl esters such as divinyl adipate;

N-vinylamides such as N-vinylpyrrolidone and N-methyl-N-vinylacetamide; and

styrene derivatives such as styrene, 2,4-dimethyl-α-methylstyrene, o-methylstyrene, m-methylstyrene, p-methylstyrene, 2,4-dimethylstyrene, 2,5-dimethylstyrene, 2,6-dimethylstyrene, 3,4-dimethylstyrene, 3,5-dimethylstyrene, 2,4,6-trimethylstyrene, 2,4,5-trimethylstyrene, pentamethylstyrene, o-ethylstyrene, m-ethylstyrene, p-ethylstyrene, o-chlorostyrene, m-chlorostyrene, p-chlorostyrene, o-bromostyrene, m-bromostyrene, p-bromostyrene, o-methoxystyrene, m-methoxystyrene, p-methoxystyrene, o-hydroxystyrene, m-hydroxystyrene, p-hydroxystyrene, 2-vinylbiphenyl, 3-vinylbiphenyl, 4-vinylbiphenyl, 1-vinylnaphthalene, 2-vinylnaphthalene, 4-vinyl-p-terphenyl, 1-vinylanthracene, α-methylstyrene, o-isopropenyltoluene, m-isopropenyltoluene, p-isopropenyltoluene, 2,4-dimethyl-α-methylstyrene, 2,3-dimethyl-α-methylstyrene, 3,5-dimethyl-α-methylstyrene, p-isopropyl-α-methylstyrene, α-ethylstyrene and α-chlorostyrene.

Examples of the compounds having two or more vinyl groups include:

ethylene glycol divinyl ether, 1,4-butanediol divinyl ether, 1,6-hexanediol divinyl ether, 1,9-nonanediol divinyl ether, cyclohexanedimethanol divinyl ether, diethylene glycol divinyl ether and triethylene glycol divinyl ether;

polyfunctional vinyl ethers such as trimethylolpropane trivinyl ether and pentaerythritol tetravinyl ether; and

divinylbenzene and divinylbiphenyl.

Examples of the compounds having allyl groups include:

compounds having one allyl group such as allyl alcohol, ethylene glycol monoallyl ether, allylamine and allylglycidyl ether, and allyl esters such as allyl acetate and allyl benzoate; and

compounds having two or more allyl groups such as diallylamine, diallyl 1,4-cyclohexanedicarboxylate, diallyl phthalate, diallyl terephthalate and diallyl isophthalate.

Examples of the compounds having epoxy groups include:

compounds having one epoxy group such as glycidol and cyclohexene oxide; and

compounds having two or more epoxy groups such as bisphenol A epoxy resin, hydrogenated bisphenol A epoxy resin, brominated bisphenol A epoxy resin, bisphenol F epoxy resin, novolak epoxy resin, phenol novolak epoxy resin, cresol novolak epoxy resin, alicyclic epoxy resin, N-glycidyl epoxy resin, bisphenol A novolak epoxy resin, chelate epoxy resin, glyoxal epoxy resin, amino group-containing epoxy resin, rubber-modified epoxy resin, dicyclopentadiene phenolic epoxy resin, silicone-modified epoxy resin and ε-caprolactone-modified epoxy resin.

Examples of the compounds having oxetanyl groups include:

compounds having one oxetanyl group such as 3-ethyl-3-hydroxymethyloxetane and 3-ethyl-3-methacryloxymethyloxetane; and

compounds having two or more oxetanyl groups such as ARON OXETANE OXT-121 (trade name) manufactured by TOAGOSEI CO,. LTD., and OXTP and OXBP (trade names) manufactured by Nippon Steel Chemical Co., Ltd.

Organic or inorganic fine particles are used as the component (b) in the nanoimprinting resin compositions of the invention. To achieve high effects of preventing dimensional change in curing and reducing the clinging to the mold, inorganic fine particles are preferable. From the viewpoints of availability and dispersibility in the resin component (a), silica fine particles and zirconia fine particles are preferable.

The average particle diameter of the component (b) may be determined by observing a dispersion of the organic or inorganic fine particles with a transmission electron microscope (TEM) to measure the maximum diameters of several tens to several hundreds of particles in the field of view, and number-averaging the maximum diameters. The average particle diameter is preferably not more than 100 nm, and more preferably not more than 50 nm. When the line width of the depression/protrusion patterns is 100 nm or less, it is preferable to use fine particles having an average particle diameter smaller than the line width. If the particle diameter of the component (b) is excessively large, the obtainable film cannot be nanoimprinted with a pattern precisely and can damage the mold.

The component (a) and the component (b) are preferably used in a ratio of 100 parts by mass of the component (a) and 10 to 400 parts by mass of the component (b), and more preferably 50 to 200 parts by mass of the component (b). Insufficient amounts of the component (b) can result in poor shape retention properties after a pattern is transferred to the film, or large cure shrinkage of the film. Excessive amounts of the component (b) can result in poor curing properties or brittle patterned films.

The nanoimprinting resin compositions preferably contain a polymerization initiator (c) in addition to the components (a) and (b) in order to facilitate the curing, and may further contain a solvent, a viscosity modifier, a dispersant or a surface conditioner.

Examples of the components (c) for the cases where the polymerizable groups of the component (a) are (meth)acryloyl groups, vinyl groups or allyl groups include:

thermal radical polymerization initiators such as:

organic peroxides such as methyl ethyl ketone peroxide, cyclohexanone peroxide, methylcyclohexanone peroxide, methyl acetate peroxide, acetyl acetate peroxide, 1,1-bis(t-butylperoxy)butane, 1,1-bis(t-butylperoxy)cyclohexane, 1,1-bis(t-butylperoxy)-2-methylcyclohexane, 1,1-bis(t-butylperoxy)-3,3,5-trimethylcyclohexane, 1,1-bis(t-butylperoxy)cyclododecane, 1,1-bis(t-hexylperoxy)cyclohexane, 1,1-bis(t-hexylperoxy)-3,3,5-trimethylcyclohexane, 2,2-bis(4,4-di-t-butylperoxycyclohexyl)propane, t-butyl hydroperoxide, t-hexyl hydroperoxide, 1,1,3,3-tetramethylbutyl hydroperoxide, cumene hydroperoxide, p-methyl hydroperoxide, diisopropylbenzene hydroperoxide, di-t-butyl peroxide, dicumyl peroxide, t-butylcumyl peroxide, α,α′-bis(t-butylperoxy)diisopropylbenzene, 2,5-dimethyl-2,5-bis(t-butylperoxy)hexane, 2,5-dimethyl-2,5-bis(t-butylperoxy)hexyne-3, isobutyryl peroxide, 3,3,5-trimethylhexanoyl peroxide, octanoyl peroxide, lauroyl peroxide, stearoyl peroxide, succinic acid peroxide, m-toluoyl benzoyl peroxide, benzoyl peroxide, di-n-propyl peroxydicarbonate, diisopropyl peroxydicarbonate, bis(4-t-butylcyclohexyl) peroxydicarbonate, di-2-ethoxyethyl peroxydicarbonate, di-2-ethoxyhexyl peroxydicarbonate, di-3-methoxybutyl peroxydicarbonate, di-s-butyl peroxydicarbonate, di(3-methyl-3-methoxybutyl) peroxydicarbonate, α,α′-bis(neodecanoylperoxy)diisopropylbenzene, t-butyl peroxyneodecanoate, t-hexyl peroxyneodecanoate, 1,1,3,3-tetramethylbutyl peroxyneodecanoate, 1-cyclohexyl-1-methylethyl peroxyneodecanoate, cumyl peroxyneodecanoate, t-butyl peroxypivalate, t-hexyl peroxypivalate, t-butyl peroxy-2-ethylhexanoate, t-hexyl peroxy-2-ethylhexanoate, 1,1,3,3-tetramethylbutyl peroxy-2-ethylhexanoate, 2,5-dimethyl-2,5-bis(2-ethylhexanoylperoxy)hexane, 1-cyclohexyl-1-methylethyl peroxy-2-ethylhexanoate, t-butyl peroxy-3,5,5-trimethylhexanoate, t-butyl peroxyisopropyl monocarbonate, t-hexyl peroxyisopropyl monocarbonate, t-butyl peroxy-2-ethylhexyl monocarbonate, t-butyl peroxyallyl monocarbonate, t-butyl peroxyisobutyrate, t-butyl peroxymaleate, t-butyl peroxybenzoate, t-hexyl peroxybenzoate, t-butyl peroxy-m-toluoylbenzoate, t-butyl peroxylaurate, t-butyl peroxyacetate, bis(t-butylperoxy) isophthalate, 2,5-dimethyl-2,5-bis(m-toluoylperoxy)hexane, 2,5-dimethyl-2,5-bis(benzoylperoxy)hexane, t-butyl trimethylsilyl peroxide, 3,3′,4,4′-tetra(t-butylperoxycarbonyl)benzophenone and 2,3-dimethyl-2,3-diphenylbutane; and azo compounds such as 1-[(1-cyano-1-methylethyl)azo]formamide, 1,1′-azobis(cyclohexane-1-carbonitrile), 2,2′-azobis(2-methylbutyronitrile), 2,2′-azobisisobutyronitrile, 2,2′-azobis(2,4-dimethyl-4-methoxyvaleronitrile), 2,2′-azobis(2,4-dimethylvaleronitrile), 2-phenylazo-4-methoxy-2,4-dimethylvaleronitrile, 2,2′-azobis(2-methylpropionamidine) dihydrochloride, 2,2-azobis(2-methyl-N-phenylpropionamidine) dihydrochloride, 2,2′-azobis[N-(4-chlorophenyl)-2-methylpropionamidine]dihydrochloride, 2,2′-azobis[N-(4-hydrophenyl)-2-methylpropionamidine]dihydrochloride, 2,2′-azobis[2-methyl-N-(2-propenyl)propionamidine]dihydrochloride, 2,2′-azobis[N-(2-hydroxyethyl)-2-methylpropionamidine]dihydrochloride, 2,2′-azobis[2-methyl-N-(phenylmethyl)propionamidine]dihydrochloride, 2,2′-azobis[2-(2-imidazolin-2-yl)propane]dihydrochloride, 2,2′-azobis[2-(2-imidazolin-2-yl)propane]dihydrochloride, 2,2′-azobis[2-(5-methyl-2-imidazolin-2-yl)propane]dihydrochloride, 2,2′-azobis{2-[1-(2-hydroxyethyl)-2-imidazolin-2-yl]propane}dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl) propane]dihydrochloride, 2,2′-azobis[2-(5-hydroxy-3,4,5,6-tetrahydropyrimidin-2-yl)propane]dihydrochloride, 2,2′-azobis(2-methylpropionamide), 2,2′-azobis[2-methyl-N-(2-hydroxyethyl)propionamide], 2,2′-azobis{2-methyl-N-[1,1-bis(hydroxymethyl)-2-hydroxyethyl]propionamide}, 2,2′-azobis{2-methyl-N-[1,1-bis(hydroxymethyl) ethyl]propionamide}, 2,2′-azobis(2-methylpropane), 2,2′-azobis(2,4,4-trimethylpentane), dimethyl-2,2′-azobis(2-methylpropionate), 4,4′-azobis(4-cyanopentanoic acid) and 2,2′-azobis[2-(hydroxymethyl)propionitrile];

acetophenone radical photopolymerization initiators such as 4-phenoxydichloroacetophenone, 4-t-butyl-dichloroacetophenone, 4-t-butyl-trichloroacetophenone, diethoxyacetophenone, 2-hydroxy-2-phenyl-1-phenylpropan-1-one, 1-(4-dodecylphenyl-2-hydroxy-2-methylpropan-1-one, 1-(4-isopropylphenyl)-2-hydroxy-2-methylpropan-1-one, 4-(2-hydroxyethoxy)-phenyl-(2-hydroxy-2-propyl) ketone, 1-hydroxycyclohexyl phenyl ketone and 2-methyl-1-[4-(methylthio) phenyl]-2-morpholinopropane-1;

benzoin radical photopolymerization initiators such as benzoin, benzoin methyl ether, benzoin isopropyl ether, benzoin isobutyl ether and benzyl methyl ketal;

benzophenone radical photopolymerization initiators such as benzophenone, benzoylbenzoic acid, methyl benzoylbenzoate, 4-phenylbenzophenone, hydroxybenzophenone, acrylated benzophenone, 4-benzoyl-4′-methyldiphenyl sulfide, 3,3′-dimethyl-4-methoxybenzophenone, 4,4′-dimethylaminobenzophenone, 4,4′-diethylaminobenzophenone and 3,3′,4,4′-tetra(t-butylperoxycarbonyl)benzophenone;

thioxanthone radical photopolymerization initiators such as thioxanthone, 2-chlorothioxanthone, 2-methylthioxanthone, 2,4-dimethylthioxanthone, 2,4-diethylthioxanthone, 2,4-diisopropylthioxanthone, isopropylthioxanthone, 1-chloro-4-propoxythioxanthone and 2,4-dichlorothioxanthone;

ketone radical photopolymerization initiators such as α-acyloxime ester, methylphenyl glyoxylate, benzyl, 9,10-phenanthrenequinone, camphorquinone, dibenzosuberone, 2-ethylanthraquinone and 4′,4″-diethylisophthalophenone;

imidazole radical photopolymerization initiators such as 2,2′-bis(2-chlorophenyl)-4,4′,5,5′-tetraphenyl-1,2′-imidazole;

acylphosphine oxide radical photopolymerization initiators such as 2,4,6-trimethylbenzoyldiphenylphosphine oxide:

carbazole radical photopolymerization initiators; and

Lewis acid onium salt radical photopolymerization initiators such as triphenylphosphonium hexafluoroantimonate, triphenylphosphonium hexafluorophosphate, p-(phenylthio)phenyldiphenylsulfonium hexafluoroantimonate, 4-chlorophenyldiphenylsulfonium hexafluorophosphate and (2,4-cyclopentadien-1-yl)[(1-methylethyl) benzene]-iron-hexafluorophosphate.

Examples of the components (c) for the cases where the polymerizable groups of the component (a) are epoxy groups include:

anionic initiators such as imidazoles such as melamine, imidazole, 2-methylimidazole, 2-undecylimidazole, 2-heptacylimidazole, 2-ethyl-4-ethylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triadine, 2,4-diamino-6-[2′-undecylimidazolyl-(1′)]-ethyl-s-triadine, 2,4-diamino-6-[2′-ethyl-4′-imidazolyl-(1′)]-ethyl-s-triadine, 2,4-diamino-6-[2′-methylimidazolyl-(1′)]-ethyl-s-triadine isocyanuric acid adduct, 2-phenylimidazole isocyanuric acid adduct, 2-methylimidazole isocyanuric acid adduct, 2-phenyl-4,5-dihydroxymethylimidazole, 2-phenyl-4-methyl-5-hydroxymethylimidazole, 2,3-dihydro-1H-pyrolo[1,2-a]benzimidazole, 4,4′-methylenebis(2-ethyl-5-methylimidazole) and 1-dodecyl-2-methyl-3-benzylimidazolium chloride; and

organic strong bases and salts thereof such as 1,8-diazabicyclo(5.4.0)undecene-7 and phenol salts, octylates, p-toluenesulfonates, formates, orthophthalates and phenol novolak resin salts thereof, 1,5-diazabicyclo(4.3.0)nonene-5 and phenol novolak resin salts thereof, quaternary phosphonium bromide and ureas such as aromatic dimethylurea and aliphatic dimethylurea;

photo or cationic polymerization initiators such as sulfonium salts, iodonium salts, diazonium salts and allene-ion complexes; and

thermal cationic polymerization initiators such as silanol cationic catalysts such as triphenyl silanol and aluminum chelate catalysts such as aluminum tris(acetylacetone).

These polymerization initiators may be used singly, or two or more kinds may be used in combination. They are preferably used in amounts of 0.01 to 10 parts by mass based on 100 parts by mass of the component (a).

The nanoimprinting resin compositions may contain solvents without limitation. It is preferable to use solvents which satisfactorily dissolve the components and are suited for methods of applying the composition to substrates.

The amount of the solvents is preferably not more than 99900 parts by mass, and more preferably not more than 9900 parts by mass based on 100 parts by mass of the component (a) and the component (b) combined. If the amount of the solvents is excessively large, the obtainable resin composition may not be applied to a substrate in a desired thickness.

When additives such as viscosity modifiers, dispersants and surface conditioners are used in the nanoimprinting resin composition, the total amount of such additives is preferably not more than 30 parts by mass based on 100 parts by mass of the component (a) and the component (b) combined. Excessive amounts of the additives can deteriorate physical and chemical durability of the films obtained from the resin compositions.

The nanoimprinting resin compositions may be applied to substrates by any methods without limitation. Exemplary methods are spin coating and dip coating. It is preferable to adopt a method capable of spreading the resin composition in a uniform thickness on a substrate. The film thickness of the resin composition is preferably about ⅓ to twice the height of the depressions and protrusions in the patterns of the mold which will be pressed against the film. If the film thickness is too small, the resin composition will not fill sufficiently the depressions and protrusions of the mold. If the thickness is excessively large, a residual film will remain on the mold.

After the nanoimprinting resin composition is applied to a substrate, it is patterned by a nanoimprinting method. Herein, the mold may be pressed by any methods without limitation. For example, it may be pressed by hand or with a high pressure by means of a press machine.

When a mold is pressed against the nanoimprinting resin composition spread on a substrate, the mold temperature is not particularly limited. In the case where the resin composition has high viscosity and low fluidity, the mold is preferably heated to permit the resin composition to fill the mold patterns sufficiently. In this case, the mold temperature is preferably not more than 300° C. to avoid decomposition of the resin composition.

After the mold is pressed against the resin film, the patterns may be fixed to the resin by a photocuring method or a thermal curing method. Photocuring methods are preferable because quick curing and high throughput are easily achieved. In view of handling properties of the resin compositions, it is particularly preferable to adopt a photocuring method with a UV light having a wavelength of not more than 400 nm.

The light may be applied at any timing without limitation, but is preferably applied after 5 to 120 seconds after the mold is pressed. If the light is applied too early, the resin composition is irradiated before it fills the mold sufficiently, resulting in insufficient curing. If the timing is too late, production efficiency is deteriorated.

The irradiation time is not particularly limited. In view of curing degree of the films and productivity, the irradiation time is preferably in the range of 5 seconds to 30 minutes, and particularly preferably 5 seconds to 10 minutes.

The light sources for use in the photocuring methods in the invention are not particularly limited. Light sources generally used in the curing of photocurable resins may be used, with examples including UV LED lamps, mercury lamps and xenon lamps.

The nanoimprinting resin compositions may be photocured under heating to accelerate the curing or to improve properties of the obtainable patterned films. The heating temperature is preferably not more than 300° C. to avoid decomposition of the resin compositions.

The resin compositions may be pressed with a mold or irradiated with light in any atmosphere without limitation. Vacuum atmosphere is preferable to avoid any bubbles in the films. Vacuum atmosphere is also preferable to prevent polymerization inhibition by oxygen when the polymerizable groups in the polymerizable resin composition have a carbon-carbon double bond, such as (meth)acryloyl groups, allyl groups and vinyl groups.

After the nanoimprinting resin composition is patterned, it may be heated prior to use in order to increase heat resistance or mechanical strength of the films. The heating methods are not particularly limited. In a preferred embodiment, the temperature is gradually increased but is controlled below the glass transition temperature of the film to avoid deformation of the pattern, and the upper limit temperature is not more than 300° C. to prevent thermal decomposition of the resin composition.

### EXAMPLES

Hereinbelow, the present invention will be described in greater detail by examples without limiting the scope of the invention.

### Example 1

A photocurable acrylic resin composition containing silica fine particles (ADEKA OPTOMER KRX-574-36SF, manufactured by ADEKA CORPORATION) was used as a nanoimprinting resin composition. The composition ADEKA OPTOMER KRX-574-36SF (solid concentration: 45% by mass) contained, in the solid, 70% by mass of a resin which had an acryloyl group as a polymerizable functional group in the molecule, and 30% by mass of silica fine particles with an average particle diameter of 30 nm. To 2 g of the resin composition, propylene glycol monomethyl ether acetate as a solvent was added to adjust the total mass at 10 g. The solution thus obtained was dropped on a glass circular plate 1.8 inch in diameter and was spin coated at 5000 rpm. The thickness of the resin composition film on the glass circular plate was measured on optical thickness meter Film Tek 2000 manufactured by SCI. The average film thickness was about 80 nm.

Subsequently, a release agent (DURASURF HD-1100, manufactured by Daikin Chemicals Sales Co., Ltd.) was applied to a quartz glass mold shown in FIG. 1. The patterned surface of the mold was brought into contact with the resin-coated surface of the glass circular plate having the resin composition film, and they were set in UV nanoimprinting press machine ST50 (manufactured by TOSHIBA MACHINE CO., LTD.) and were pressed together at a load of 0.3 t for 30 seconds. UV light having 365 nm wavelength and 6.5 mW intensity was applied to the film, and the film was pressed for another 120 seconds. The circular plate carrying the mold was taken out from the press machine, and the mold was removed. The film on the glass circular plate was observed and was found to be free of defects such as unevenness or transfer failure.

### Example 2

To 2 g of a photocurable acrylic resin composition (ADEKA OPTOMER KRX-574-76, manufactured by ADEKA CORPORATION), propylene glycol monomethyl ether acetate as a solvent was added to adjust the total mass at 10 g. Separately, 2.7 g of a nano zirconia dispersion (SDK-001P, manufactured by SUMITOMO OSAKA CEMENT Co., Ltd.) was combined with propylene glycol monomethyl ether acetate as a solvent to a total mass of 4.2 g. A nanoimprinting resin composition was obtained by mixing 7 g of the former mixture and 3 g of the latter mixture. The composition ADEKA OPTOMER KRX-574-76 (solid concentration: 45% by mass) was a solution of a mixture that contained a resin having an acryloyl group as a polymerizable functional group in the molecule. The dispersion SDK-001P (solid concentration: 14.2% by mass) was a dispersion of nano zirconia having an average particle diameter of 3 nm in propylene glycol monomethyl ether. The solution obtained above was dropped on a glass circular plate 1.8 inch in diameter and was spin coated at 2500 rpm. The thickness of the resin composition film on the glass circular plate was measured on optical thickness meter Film Tek 2000 manufactured by SCI. The average film thickness was about 80 nm.

Subsequently, a quartz glass mold shown in FIG. 1 was placed on the resin composition film and they were pressed and UV irradiated in the same manner as in Example 1, except that the pressing time with UV irradiation was changed to 300 seconds. The mold was removed, and the nanoimprinted film on the glass circular plate was observed and was found to be free of defects such as unevenness or transfer failure.

### Example 3

To 2 g of a photocurable acrylic resin composition (ADEKA OPTOMER KRX-574-76, manufactured by ADEKA CORPORATION), propylene glycol mono-n-propyl ether as a solvent was added to adjust the total mass at 10 g. Separately, 3 g of a nano titania dispersion (QUEEN TITANIC special grade, manufactured by JGC Catalysts and Chemicals Ltd.) having an average particle diameter of 10 nm was combined with propylene glycol mono-n-propyl ether as a solvent to a total mass of 9 g. A nanoimprinting resin composition was obtained by mixing 7 g of the former mixture and 3 g of the latter mixture. The composition ADEKA OPTOMER KRX-574-76 (solid concentration: 45% by mass) was a solution of a mixture that contained a resin having an acryloyl group as a polymerizable functional group in the molecule. The dispersion QUEEN TITANIC special grade (solid concentration: 30.5% by mass) was a dispersion of nano zirconia in methanol. The solution obtained above was applied on a glass circular plate and the film thickness was measured in the same manner as in Example 2, resulting in an average film thickness of about 80 nm.

Subsequently, a quartz glass mold shown in FIG. 1 was placed on the resin composition film and they were pressed and UV irradiated in the same manner as in Example 1. The mold was removed, and the nanoimprinted film on the glass circular plate was observed and was found to be free of defects such as unevenness or transfer failure.

### Comparative Example 1

A photocurable resin composition containing no fine particles (PAK-01-60, manufactured by Toyo Gosei Co., Ltd.) as a nanoimprinting resin composition was applied on a glass circular plate and the film thickness was measured in the same manner as in Example 2, resulting in an average film thickness of about 80 nm.

Subsequently, a quartz glass mold shown in FIG. 1 was placed on the resin composition film and they were pressed and UV irradiated in the same manner as in Example 1. The mold was removed, and the film on the glass circular plate was observed and was found to contain five uneven spots with a diameter of 7 to 8 mm.

1. A nanoimprinting resin composition comprising as essential components:
(a) a compound having at least one polymerizable group in the molecule, and
(b) organic or inorganic fine particles.

2. The nanoimprinting resin composition according to claim 1, wherein not less than 30% by mass of the component (a) is a compound having at least two polymerizable groups in the molecule.

3. The nanoimprinting resin composition according to claim 1, wherein not less than 30% by mass of the component (a) is a compound having at least one (meth)acryloyl group in the molecule.

4. The nanoimprinting resin composition according to claim 1, wherein the component (b) is inorganic fine particles having an average particle diameter of not more than 100 nm.

5. The nanoimprinting resin composition according to claim 4, wherein the inorganic fine particles are at least one kind selected from the group consisting of silica fine particles, zirconia fine particles and titania fine particles.

6. The nanoimprinting resin composition according to claim 1, wherein the component (a) and the component (b) are used in a ratio of 100 parts by mass of the component (a) and 10 to 400 parts by mass of the component (b).

7. The nanoimprinting resin composition according to claim 1, wherein the nanoimprinting resin composition further comprises a polymerization initiator (c).

8. The nanoimprinting resin composition according to claim 7, wherein the component (c) is used in an amount of 0.01 to 10 parts by mass based on 100 parts by mass of the component (a).

9. A process for producing micropatterned films comprising applying the nanoimprinting resin composition of claim 1 to a substrate and patterning the composition by a nanoimprinting method.

10. The process for producing micropatterned films according to claim 9, wherein the composition is patterned by pressing a mold against the composition and applying a UV light having a wavelength of not more than 400 nm.

11. A micropatterned film obtained by the process of claim 9.

12. A process for manufacturing magnetic disk media, comprising patterning a magnetic layer through the micropatterned film of claim 11 as a mask or through a masking material patterned through the micropatterned film as a mask, by demagnetizing or removing a portion of the disk that is not masked.

13. A magnetic disk medium obtained by the process of claim 12.

14. A recording/reproducing apparatus for recording information in or reproducing information from the magnetic disk medium of claim 13.
